(19) United States
(12) Patent Application Publication
(10) Pub. No.: US 2007/0283540 A1
(43) Pub. Date: Dec. 13, 2007

(54) Buckle device

(76) Inventor: Vincent Chang, Changhua (TW)

Correspondence Address: CHARLES E. BAXLEY, ESQ., 90 JOHN STREET, THIRD FLOOR, NEW YORK, NY, 10038, US

(21) Appl. No.: 11/448,312

(22) Filed: Jun. 7, 2006

(51) Int. Cl. B25B 25/00; A43C 11/00

(52) U.S. Cl. 24/68 CD

(57) ABSTRACT

A buckle device includes a base coupled to a strap and having a chamber formed between two side panels, a connector frame is rotatably secured to the base with an axle, a shaft is attached to the connector frame. A latch is slidably attached to the connector frame to selectively lock the connector frame to the base. Another strap has an intermediate segment engaged over the shaft and engaged around the axle, and may be selectively tightened by the shaft. An anchoring device includes a resilient blade attached to the base and having a rounded member for engaging with the other strap and for anchoring the other strap to the base.

### BACKGROUND OF THE INVENTION

1. Field of the Invention

The present invention relates to a buckle device, and more particularly to a buckle device for coupling or suspending straps and having a clamping or retaining device for firmly anchoring and positioning the straps to the buckle device and for preventing the buckle device from becoming loosened from or relative to the buckle device.

2. Description of the Prior Art

Typical connector devices or buckle devices for coupling or for suspending straps have been developed for coupling two straps together, and comprises a ring or loop for attaching or coupling to a lock device, and the straps are coupled to the loop and the lock device respectively, for allowing the straps to be coupled together by engaging the loop toward the lock device.

For example, U.S. Pat. No. 4,118,833 to Knox et al. discloses one of the typical buckle devices comprising a strap ring coupled to one of the straps, and a connector frame couple to the other strap, and the strap ring may be attached to the connector frame, and may be selectively locked to the connector frame with a swinging member and a tumbler.

However, the straps may only be coupled and secured to the buckle device with the swinging member and the tumbler, but may not be solidly anchored or clamped or positioned to the buckle device and may have a good chance to be loosened form the buckle device while in use.

U.S. Pat. No. 7,020,933 to Chang discloses another typical buckle device also comprising a strap ring coupled to one of the straps, and a connector frame couple to the other strap, and the strap ring may be attached to the connector frame, and may be selectively locked to the connector frame with a swinging member and a tumbler or spring latch device.

However, the straps may also be coupled and secured to the buckle device with the swinging member and the tumbler only, and may not be solidly anchored or clamped or positioned to the buckle device and may also have a good chance to be loosened form the buckle device while in use.

The present invention has arisen to mitigate and/or obviate the afore-described disadvantages of the conventional connector or buckle devices.

### SUMMARY OF THE INVENTION

The primary objective of the present invention is to provide a buckle device for allowing two straps to be easily and quickly tightened together and having a clamping or retaining device for firmly anchoring and positioning the straps to the buckle device and for preventing the straps from becoming loosened from or relative to the buckle device.

The other objective of the present invention is to provide a buckle device including a barrel rotatably engaged onto a pivot axle which pivotally couples a connector frame to a base for engaging with the straps and for allowing the straps to be easily pulled and moved relative to the axle.

The further objective of the present invention is to provide a buckle device including a sleeve rotatably engaged onto a shaft which is attached to a connector frame, for engaging with the straps and for allowing the straps to be easily pulled and moved relative to the shaft.

In accordance with one aspect of the invention, there is provided a buckle device comprising a base including a chamber formed therein and defined between two side panels and a bottom panel, and including at least one lock notch formed therein, an axle straddled between the side panels of the base, a first strap attached to the base, a connector frame rotatably attached to the base with the axle, a shaft attached to the connector frame, a latch slidably attached to the connector frame, and engageable with the lock notch of the base, to selectively lock the connector frame to the base, a second strap including an intermediate segment engaged over the shaft and engaged around the axle, the shaft being engageable with the intermediate segment of the second strap to force and to tighten the second strap when the connector frame is moved toward the base and locked to the base at a locking position with the latch, and the shaft releasing the intermediate segment of the second strap when the connector frame is rotated away from the base at a released position, and an anchoring device may further be provided for attached to the base and for anchoring the second strap to the base and for preventing the straps from becoming loosened from or relative to the buckle device.

The connector frame includes two side plates each having a groove formed therein, and the latch includes two side catches slidably engaged through the grooves of the side plates of the connector frame, to guide the latch to slide relative to the connector frame.

The connector frame includes an ear having an aperture formed therein, and the latch includes an extension extended therefrom and slidably engaged through the aperture of the ear of the connector frame, to guide the latch to smoothly slide relative to the connector frame.

The connector frame includes an opening formed therein, and the latch includes at least one hand grip extended upwardly and outwardly through the opening of the connector frame, to allow the latch to be moved relative to the connector frame with the hand grip by the users.

The connector frame includes a spring engaged between the connector frame and the latch for biasing the latch to engage with the base. The anchoring device includes a resilient blade attached to the base for engaging with the second strap and for anchoring the second strap to the base.

The base includes a passage formed therein, the resilient blade is engaged through the passage of the base and secured to the base. The resilient blade includes a rounded member provided thereon for engaging with the second strap. The base includes a barrel rotatably engaged onto the axle, and the connector frame includes a sleeve rotatably engaged onto the shaft for engaging with the second strap and for allowing the second strap to be easily pulled and moved relative to the axle and the shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a buckle device in accordance with the present invention;

FIG. 2 is a-perspective view of the buckle device;

FIG. 3 is a cross sectional view taken along lines 3-3 of FIG. 2, having two straps attached to the buckle device;

FIGS. 4, 5 are cross sectional views similar to FIG. 3, illustrating the operation of the buckle device;

FIG. 6 is an exploded view similar to FIG. 1 illustrating the other arrangement or application of the buckle device;

FIG. 7 is an exploded view similar to FIGS. 1 and 6 illustrating the further arrangement or application of the buckle device;

FIG. 8 is an exploded view similar to FIGS. 1, 6 and 7 illustrating the still further arrangement or application of the buckle device;

FIG. 9 is an exploded view similar to FIGS. 1, 6, 7 and 8 illustrating the still further arrangement or application of the buckle device;

FIG. 10 is a perspective view of the buckle device as shown in FIG. 9;

FIG. 11 is an exploded view similar to FIGS. 1 and 6-9 illustrating the still further arrangement or application of the buckle device; and

FIG. 12 is a perspective view of the buckle device as shown in FIG. 11.

### DETAILED DESCRIPTION OF THE PREFERRED EMBODIMENT

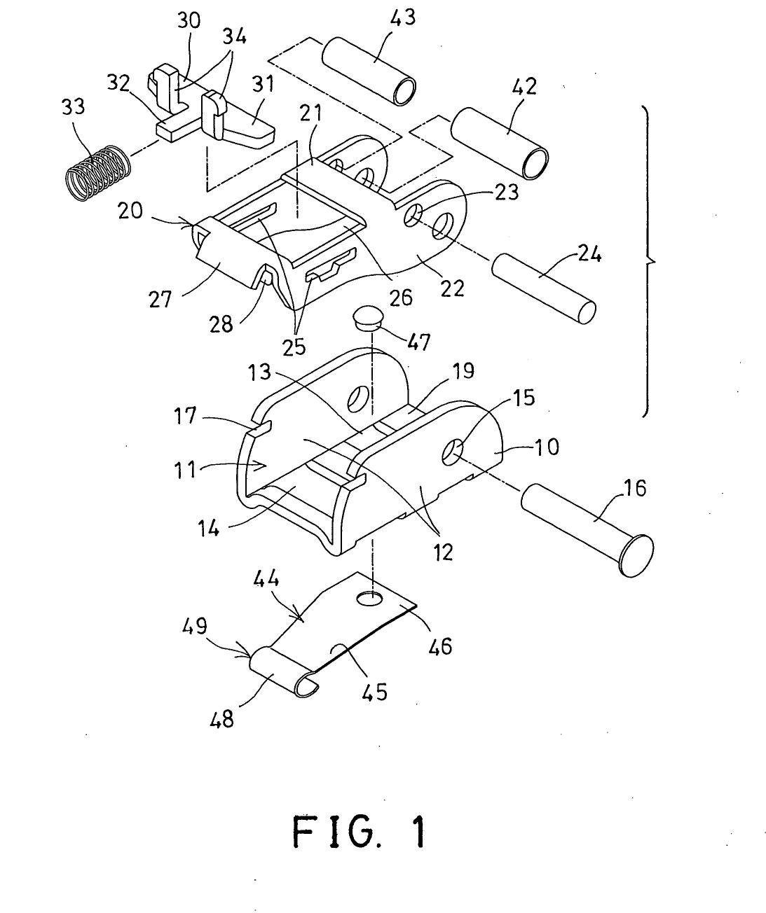

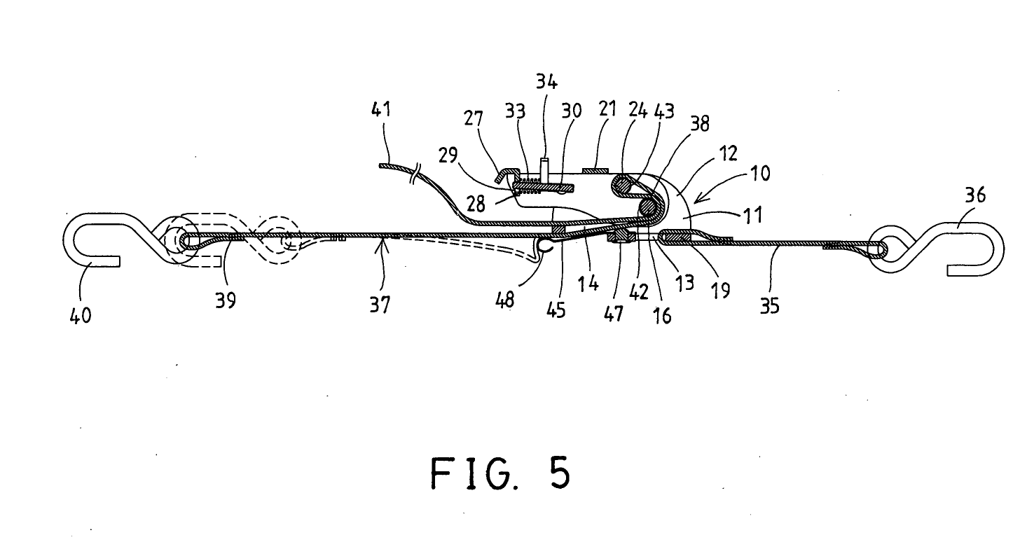

Referring to the drawings, and initially to FIGS. 1-4, a buckle device in accordance with the present invention comprises a base 10 including a chamber 11 formed therein and defined between two side panels 12 and a bottom panel 19, and including one or more, such as two passages 13, 14 formed in the bottom panel 19 thereof. Each of the side panels 12 includes an orifice 15 formed therein and aligned with each other, to receive an axle 16 therein, and to allow the axle 16 to be supported and straddled between the side panels 12. The base 10 further includes one or more, such as two lock notches 17 formed therein, such as formed in the side panels 12 thereof respectively.

A connector frame 20 is engaged onto the base 10 or received in the chamber 11 of the base 10, and is rotatably secured to the base 10 with the axle 16, and includes an upper plate 21, and two side plates 22 extended downwardly from and perpendicular to the upper plate 21. The frame 20 includes two holes 23 formed in the side plates 22 respectively, to receive or to attach or to secure a shaft 24 to the frame 20, such that the shaft 24 may be rotated in concert with the frame 20. The frame 20 further includes two grooves 25 formed in the side plates 22 respectively, and includes an opening 26 formed in the upper plate 21, and includes a handle 27 and an ear 28 extended from the upper plate 21, and the ear 28 includes an aperture 29 formed therein.

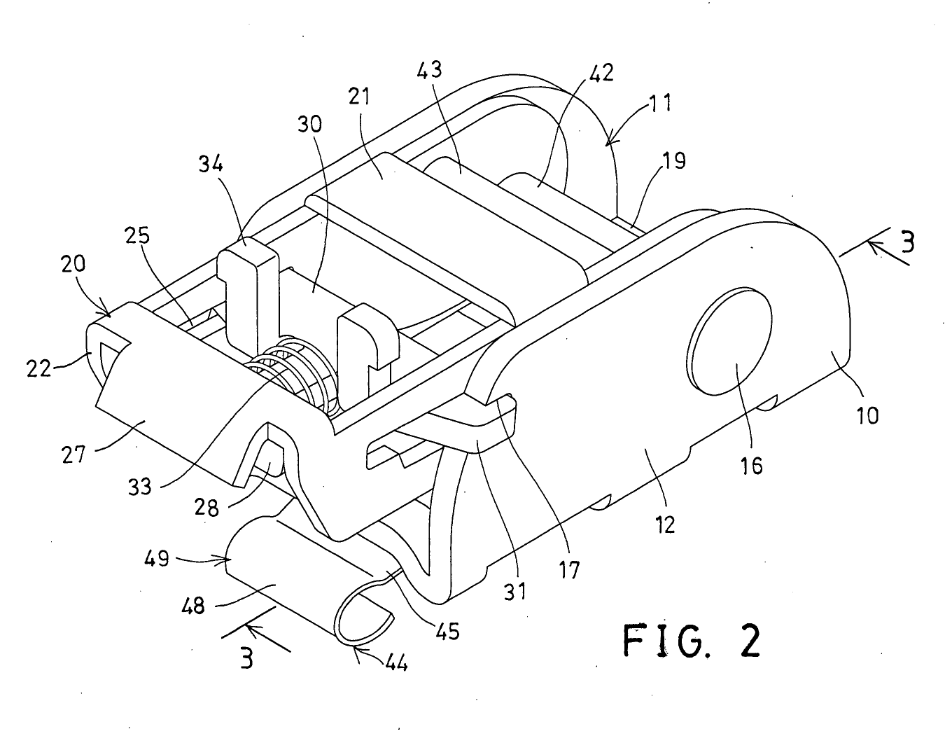

A latch 30 includes two side catches 31 extended therefrom and slidably received in the grooves 25 of the frame 20 respectively, to guide and to limit the latch 30 to slide relative to the frame 20. The latch 30 may further include an extension 32 extended therefrom and slidably received through the aperture 29 of the ear 28 of the frame 20, to further stably guide the latch 30 to slide relative to the frame 20. A spring 33 is engaged onto the extension 32 and engaged between the frame 20 and the latch 30, to bias the latch away from the ear 28, or to bias the catches 31 to engage into the lock notches 17 of the base 10 respectively (FIG. 2), and thus to lock the frame 20 to the base 10 at a locking position.

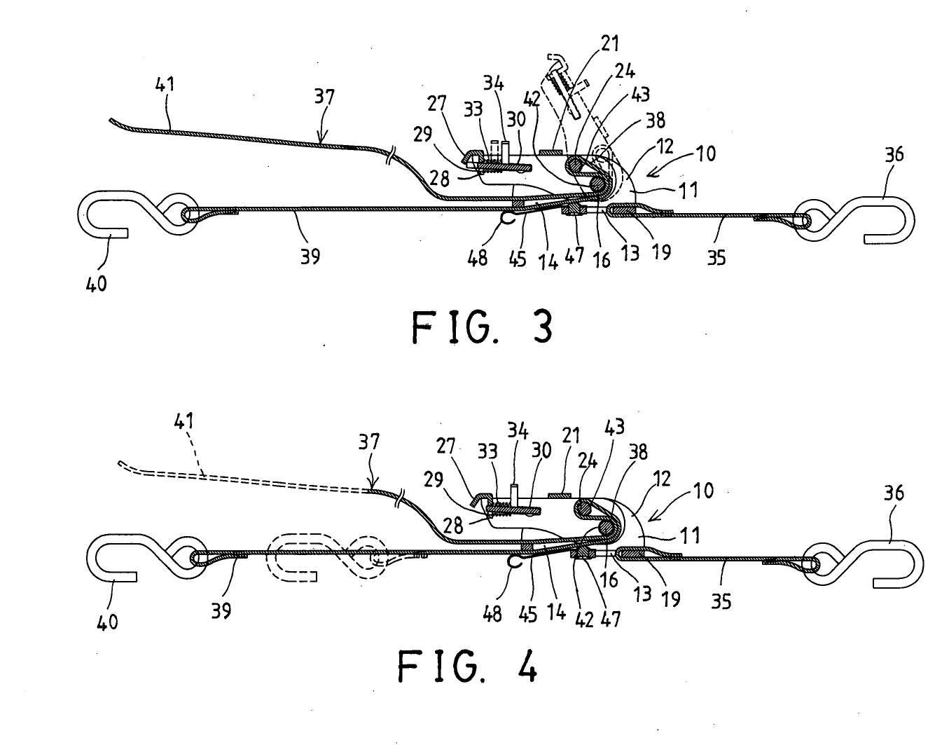

The latch 30 includes one or more hand grips 34 extended therefrom, and extended outwardly through the opening 26 of the frame 20, for allowing the latch 30 to be easily moved relative to the frame 20, against the spring 33, by the users. As shown in FIGS. 3-5, a strap 35 may be engaged through the passage 13 of the base 10, and coupled or secured to the base 10, and may be coupled to a hook 36 or the like. Another strap 37 may have an intermediate portion or segment 38 engaged through the other passage 14 of the base 10, and engaged over the axle 16 and engaged around the shaft 24, and then engaged over the axle 16 again, and may have one end coupled to another hook 40 or the like, and may have the other end 41 extended out of the base 10 and the frame 20.

In operation, when the catches 31 of the latch 30 are released from the lock notches 17 of the base 10, the frame 20 may be rotated away from the base 10 to the released position as shown in dotted lines in FIG. 3, and the shaft 24 may also be rotated or moved toward the hook 36 or away from the other hook 40, such that the intermediate segment 38 of the strap 37 may be released by the shaft 24, and such that the strap 37 may be pulled or tightened relative to the base 10 or the other strap 35 at this moment, by such as pulling the other end 41 of the strap 37. After the straps 35, 37 or the hooks 36, 40 have been tightened or forced or pulled toward each other by pulling the other end 41 of the strap 37, the frame 20 may then be forced toward the base 10, and may actuate or force the shaft 24 to engage with and to tighten the intermediate segment 38 of the strap 37. The frame 20 may then be locked to the base 10 at the locking position by the latch 30, as shown in solid lines in FIG. 3.

It is to be noted that, when the frame 20 is rotated away from or is released from the base 10 to the released position as shown in dotted lines in FIG. 3, the strap 37 may be easily and quickly pulled and tightened by pulling the other end 41 thereof, and then the frame 20 may be forced toward the base 10 to actuate the shaft 24 to tighten the intermediate segment 38 of the strap 37. The straps 35, 37 may thus be easily and quickly tightened and locked together by the relative movement between the base 10 and the frame 20 and by the latch 30. The above-described structure is typical and will not be disclosed in further details, and has been disclosed in U.S. Pat. No. 7,020,933 to Chang which may be taken as a reference for the present invention.

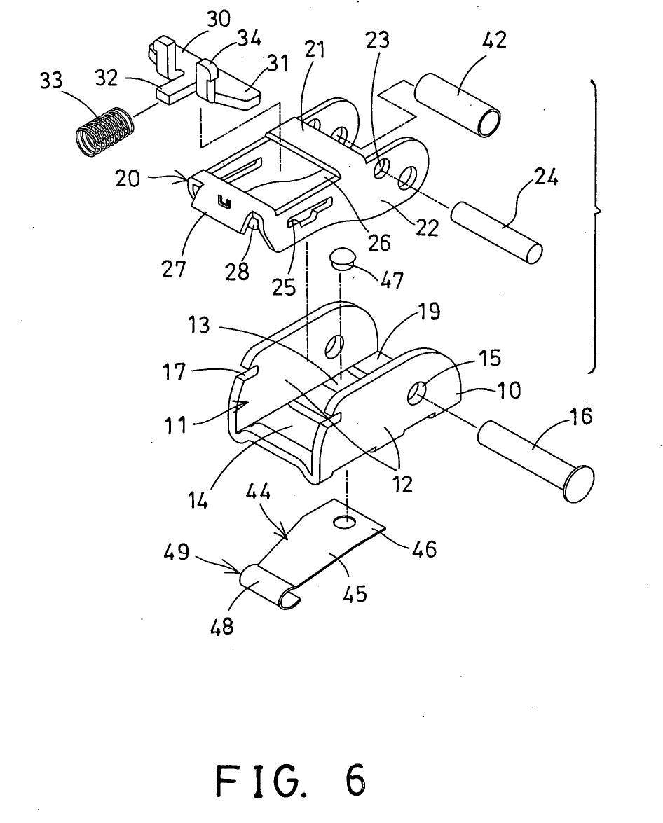

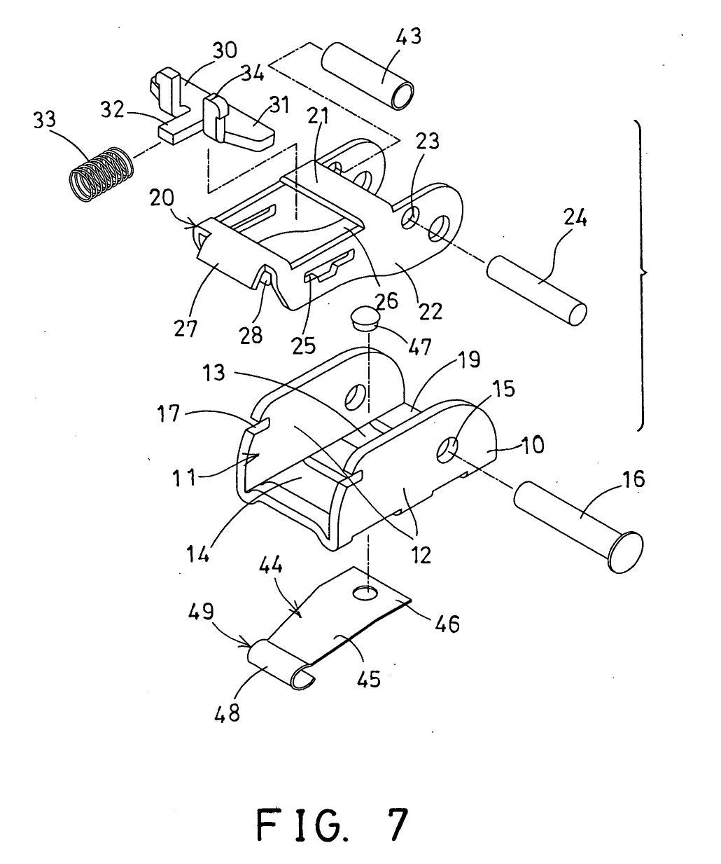

It is preferable that a barrel 42 is rotatably engaged onto the axle 16 (FIGS. 1-5, 6, 8) and engaged with the intermediate portion or segment 38 of the strap 37, for allowing the strap 37 to be easily pulled or moved relative to the axle 16, and a sleeve 43 may further be provided and selectively and rotatably engaged onto the shaft 24 (FIGS. 1-5 and 7) and also engaged with the intermediate portion or segment 38 of the strap 37, for allowing the strap 37 to be easily pulled or moved relative to the shaft 24. However, it is preferable that the barrel 42 is rotatably engaged onto the axle 16 and the sleeve 43 is simultaneously engaged onto the shaft 24 (FIGS. 1-5) for allowing the strap 37 to be easily pulled or moved relative to the axle 16 and the shaft 24.

As shown in FIGS. 1-8, the buckle device in accordance with the present invention further comprises a spring biasing means or resilient anchoring means or device 44 including a resilient blade 45 having one end 46 engaged through the other passage 14 of the base 10, and attached or secured to the base 10, such as to the bottom panel 19 of the base 10 with one or more latches or fasteners 47, and the spring biasing means or resilient anchoring means or device 44 or the resilient blade 45 is provided for engaging with the strap 37, particularly for engaging with the other end 41 of the strap 37, and for clamping or positioning or anchoring the other end 41 of the strap 37 to the base 10 (FIGS. 3-5), and for preventing the strap 37 from becoming loose or from being loosed relative to the base 10.

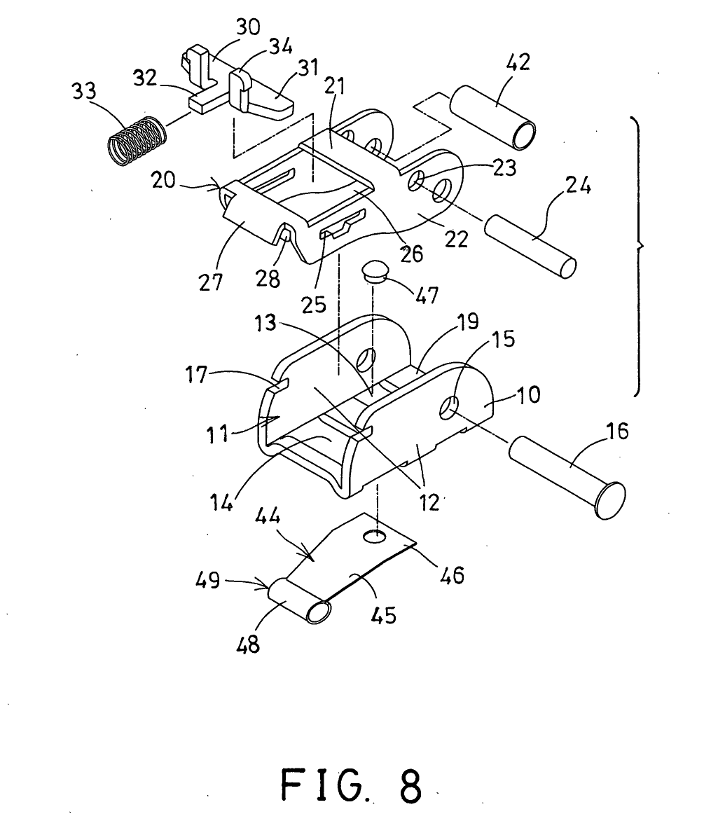

As best shown in FIGS. 1-7, the spring biasing means or resilient anchoring means or device 44 includes a curved or rounded member 48 formed or provided on the other end portion 49 of the resilient blade 45 for engaging with the strap 37 and/or for biasing or forcing the strap 37 to engage with the base 10 (FIGS. 3-5), and thus for clamping or positioning or anchoring the other end 41 of the strap 37 to the base 10. The rounded member 48 of the resilient blade 45 of the spring biasing means or resilient anchoring means or device 44 may also be formed into the other shapes, such as the cylindrical shape as shown in FIG. 8, or the like.

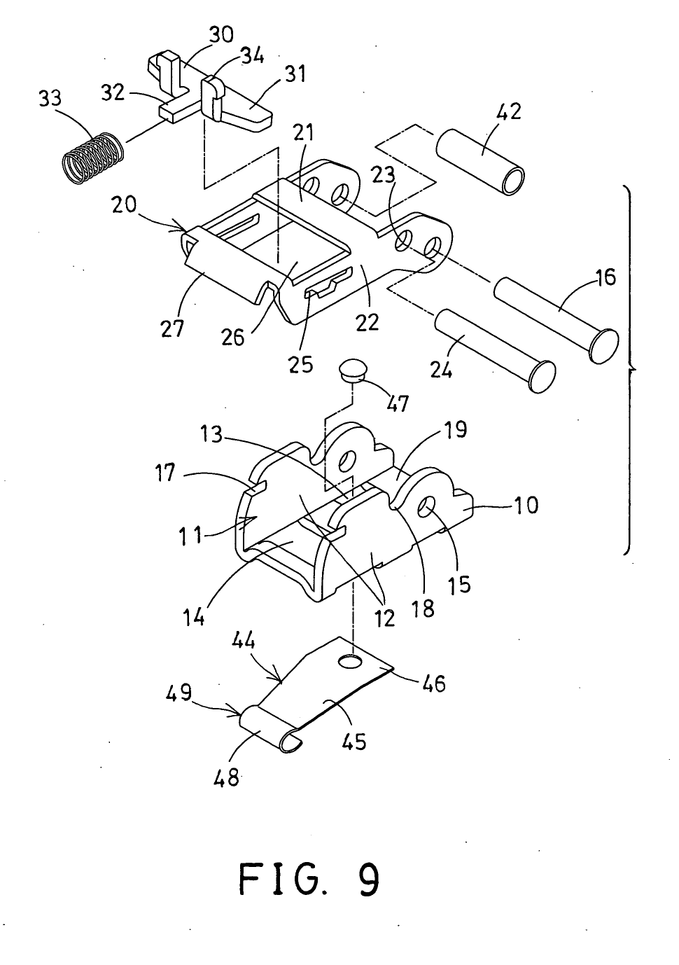

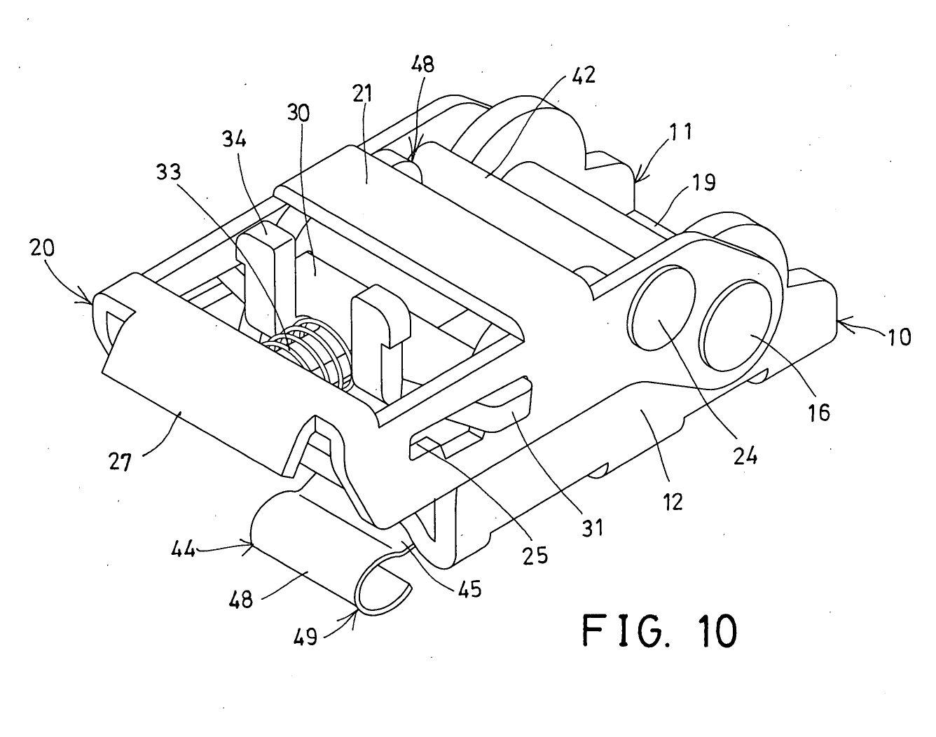

Alternatively, as shown in FIGS. 9, 10, the base 10, the frame 20 and the latch 30 include a structure similar to that shown in FIGS. 1-8, except that the side plates 22 of the frame 20 are engaged onto the side panels 12 of the base 10 or located outside the base 10, and the base 10 may include a curved depression 18 formed in each of the side panels 12 thereof for receiving or resting the shaft 24.

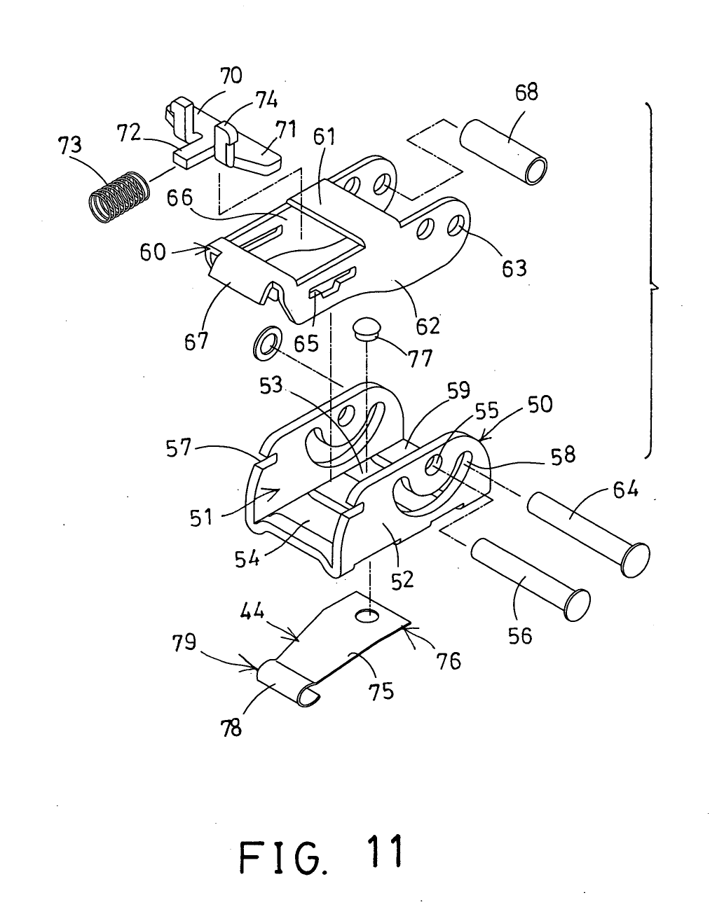

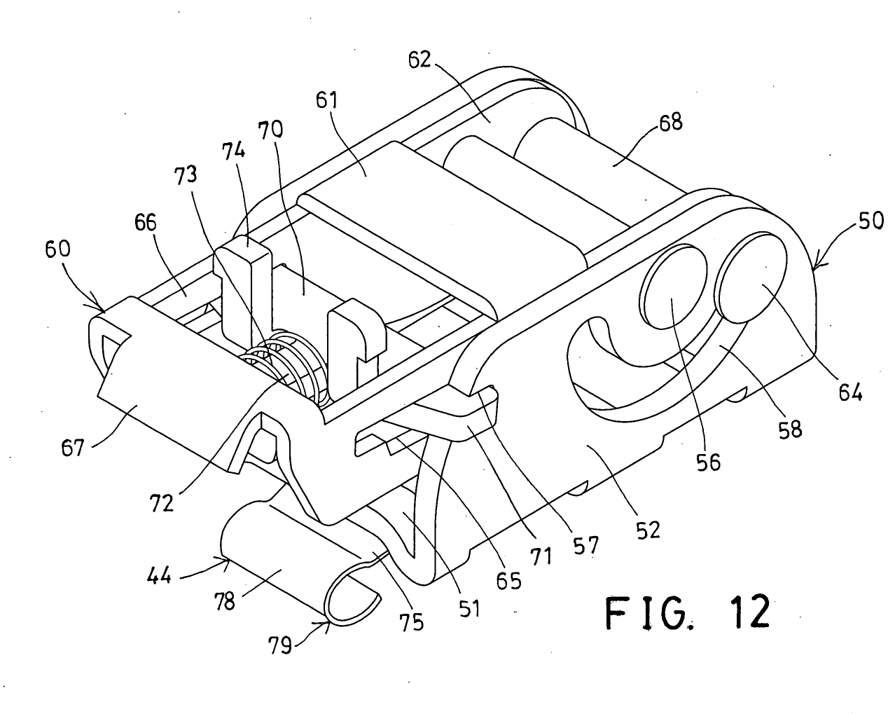

Further alternatively, as shown in FIGS. 11, 12, the buckle device also comprises a base 50 including a chamber 51 formed therein and defined between two side panels 52 and a bottom panel 59, and including one or more, such as two passages 53, 54 formed in the bottom panel 59 thereof. Each of the side panels 52 includes an orifice 55 formed therein and aligned with each other, to receive an axle 56 therein, and to allow the axle 56 to be supported and straddled between the side panels 52. The base 50 further includes one or more, such as two lock notches 57 formed therein, such as formed in the side panels 52 thereof respectively, and two curved slots 58 formed therein and located around the axle 56.

A connector frame 60 is engaged onto the base 50 or received in the chamber 51 of the base 50, and is rotatably secured to the base 50 with the axle 56, and includes an upper plate 61, and two side plates 62 extended downwardly from and perpendicular to the upper plate 61. The frame 60 includes two holes 63 formed in the side plates 62 respectively, to receive or to attach or to secure a shaft 64 to the frame 60, such that the shaft 64 may be rotated in concert with the frame 60, the shaft 64 is slidably engaged in the curved slots 58 of the base 50. The frame 60 further includes two grooves 65 formed in the side plates 62 respectively, and includes an opening 66 formed in the upper plate 61, and includes a handle 67 extended from the upper plate 61.

A latch 70 includes two side catches 71 extended therefrom and slidably received in the grooves 65 of the frame 60 respectively, to guide and to limit the latch 70 to slide relative to the frame 60. The latch 70 may further include an extension 72 extended therefrom and slidably engaged with the frame 60 to guide the latch 70 to slide relative to the frame 60. A spring 73 is engaged onto the extension 72 and engaged between the frame 60 and the latch 70, to bias the latch 70 away from the handle 67, or to bias the catches 71 to engage into the lock notches 57 of the base 50 respectively, and thus to lock the frame 60 to the base 50 at a locking position.

The latch 70 includes one or more hand grips 74 extended therefrom, and extended outwardly through the opening 66 of the frame 60, for allowing the latch 70 to be easily moved relative to the frame 60, against the spring 73, by the users. A sleeve 68 may further be provided and selectively and rotatably engaged onto the shaft 64 for engaging with the strap and for allowing the strap to be easily pulled or moved relative to the shaft 64. A spring biasing means or resilient anchoring means or device 75 including one end 76 attached or secured to the base 50, such as to the bottom panel 59 of the base 50 with one or more latches or fasteners 77, and the spring biasing means or resilient anchoring means or device 75 is provided for engaging with the strap and for clamping or positioning or anchoring the strap to the base 50 and for preventing the strap from becoming loosened relative to the base 50.

The spring biasing means or resilient anchoring means or device 75 also includes a curved or rounded member 78 formed or provided on the other end portion 79 thereof for engaging with the strap and/or for biasing or forcing the strap to engage with the base 50, and thus for clamping or positioning or anchoring the strap to the base 50. The rounded member 78 of the spring biasing means or resilient anchoring means or device 75 may also be formed into the other shapes, such as the cylindrical shape or the like.

Accordingly, the buckle device in accordance with the present invention may be used for allowing two straps to be easily and quickly tightened together and includes a clamping or retaining device for firmly anchoring and positioning the straps to the buckle device and for preventing the buckle device from becoming loosened from or relative to the buckle device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A buckle device comprising:
a base including a chamber formed therein and defined between two side panels and a bottom panel, and including at least one lock notch formed therein,
an axle straddled between said side panels of said base,
a first strap attached to said base,
a connector frame rotatably attached to said base with said axle,
a shaft attached to said connector frame,
a latch slidably attached to said connector frame, and engageable with said at least one lock notch of said base, to selectively lock said connector frame to said base,
a second strap including an intermediate segment engaged over said shaft and engaged around said axle, said shaft being engageable with said intermediate segment of said second strap to force and to tighten said second strap when said connector frame is moved toward said base and locked to said base at a locking position with said latch, and said shaft releasing said intermediate segment of said second strap when said connector frame is rotated away from said base at a released position, and
means for anchoring said second strap to said base.

2. The buckle device as claimed in claim 1, wherein said connector frame includes two side plates each having a groove formed therein, and said latch includes two side catches slidably engaged through said grooves of said side plates of said connector frame, to guide said latch to slide relative to said connector frame.

3. The buckle device as claimed in claim 1, wherein said connector frame includes an ear having an aperture formed therein, and said latch includes an extension extended therefrom and slidably engaged through said aperture of said ear of said connector frame, to guide said latch to slide relative to said connector frame.

4. The buckle device as claimed in claim 1, wherein said connector frame includes an opening formed therein, and said latch includes at least one hand grip extended outwardly through said opening of said connector frame, to allow said latch to be moved relative to said connector frame with said at least one hand grip.

5. The buckle device as claimed in claim 1, wherein said connector frame includes a spring engaged between said connector frame and said latch for biasing said latch to engage with said base.

6. The buckle device as claimed in claim 1, wherein said anchoring means includes a resilient blade attached to said base for engaging with said second strap and for anchoring said second strap to said base.

7. The buckle device as claimed in claim 6, wherein said base includes a passage formed therein, said resilient blade is engaged through said passage of said base and secured to said base.

8. The buckle device as claimed in claim 6, wherein said resilient blade includes a rounded member provided thereon for engaging with said second strap.

9. The buckle device as claimed in claim 1, wherein said base includes a barrel rotatably engaged onto said axle.

10. The buckle device as claimed in claim 1, wherein said connector frame includes a sleeve rotatably engaged onto said shaft.
